(19) United States
(12) Patent Application Publication
(10) Pub. No.: US 2015/0169780 A1
(43) Pub. Date: Jun. 18, 2015

(54) METHOD AND APPARATUS FOR UTILIZING SENSOR DATA FOR AUTO BOOKMARKING OF INFORMATION

(71) Applicant: Nokia Corporation, Espoo (FI)

(72) Inventor: Pranav Mishra, Bangalore (IN)

(21) Appl. No.: 14/419,061

(22) PCT Filed: Sep. 11, 2013
(86) PCT No.: PCT/IB2013/058446

§ 371 Date: Feb. 2, 2015

(30) Foreign Application Priority Data
Oct. 9, 2012 (IN) 4206/CHE/2012

(51) Int. Cl. G06F 17/30; H04L 29/08

(52) U.S. Cl. CPC G06F 17/30884; H04L 67/10

(57) ABSTRACT

An approach is provided for utilizing sensor data for auto bookmarking of information in one or more applications. One or more applications on a device and/or at service provider may process sensor data to determine one or more items at which at least one user is looking. Further, the one or more applications may bookmark the one or more items, associated information, or a combination thereof in at least one application. In some embodiments the sensor data may include gaze-tracking information, physical movement information, one or more user gestures, or a combination thereof. In other embodiments, one or more images of the one or more items may be captured.

### BACKGROUND

Service providers and device manufacturers (e.g., wireless, cellular, etc.) are continually challenged to deliver value and convenience to consumers by, for example, providing compelling network services. One area of interest has been in development of applications and services whereby users may utilize various sensors on various user devices to capture various data, which may be used in providing a range of services, information, content, and the like by applications, service providers, and/or content providers. For example, the data may indicate location information that may be utilized by various applications (e.g., a map application) and/or service providers to determine one or more services, one or more points of interest (POIs), one or more content items, etc. that may be associated and/or may be available at the indicated location. Accordingly, service providers and device manufacturers face significant technical challenges in providing devices and applications for providing various services based on sensor information associated with users.

### SOME EXAMPLE EMBODIMENTS

Therefore, there is a need for an approach for efficiently utilizing sensor data for auto bookmarking of information in one or more applications.

According to one embodiment, a method comprises processing and/or facilitating a processing of sensor data to determine one or more items at which at least one user is looking, one or more information items associated with the one or more items, or a combination thereof The method also comprises causing, at least in part, a bookmarking of the one or more items, the one or more information items, or a combination thereof in at least one application.

According to another embodiment, an apparatus comprises at least one processor, and at least one memory including computer program code for one or more computer programs, the at least one memory and the computer program code configured to, with the at least one processor, cause, at least in part, the apparatus to process and/or facilitate a processing of sensor data to determine one or more items at which at least one user is looking, one or more information items associated with the one or more items, or a combination thereof The apparatus is further caused to cause, at least in part, a bookmarking of the one or more items, the one or more information items, or a combination thereof in at least one application.

According to another embodiment, a computer-readable storage medium carrying one or more sequences of one or more instructions which, when executed by one or more processors, cause, at least in part, an apparatus to process and/or facilitate a processing of sensor data to determine one or more items at which at least one user is looking, one or more information items associated with the one or more items, or a combination thereof. The apparatus is further caused to cause, at least in part, a bookmarking of the one or more items, the one or more information items, or a combination thereof in at least one application.

According to another embodiment, an apparatus comprises means for processing and/or facilitating a processing of sensor data to determine one or more items at which at least one user is looking, one or more information items associated with the one or more items, or a combination thereof. The apparatus further comprises means for causing, at least in part, a bookmarking of the one or more items, the one or more information items, or a combination thereof in at least one application.

In addition, for various example embodiments of the invention, the following is applicable: a method comprising facilitating a processing of and/or processing (1) data and/or (2) information and/or (3) at least one signal, the (1) data and/or (2) information and/or (3) at least one signal based, at least in part, on (including derived at least in part from) any one or any combination of methods (or processes) disclosed in this application as relevant to any embodiment of the invention.

For various example embodiments of the invention, the following is also applicable: a method comprising facilitating access to at least one interface configured to allow access to at least one service, the at least one service configured to perform any one or any combination of network or service provider methods (or processes) disclosed in this application.

For various example embodiments of the invention, the following is also applicable: a method comprising facilitating creating and/or facilitating modifying (1) at least one device user interface element and/or (2) at least one device user interface functionality, the (1) at least one device user interface element and/or (2) at least one device user interface functionality based, at least in part, on data and/or information resulting from one or any combination of methods or processes disclosed in this application as relevant to any embodiment of the invention, and/or at least one signal resulting from one or any combination of methods (or processes) disclosed in this application as relevant to any embodiment of the invention.

For various example embodiments of the invention, the following is also applicable: a method comprising creating and/or modifying (1) at least one device user interface element and/or (2) at least one device user interface functionality, the (1) at least one device user interface element and/or (2) at least one device user interface functionality based at least in part on data and/or information resulting from one or any combination of methods (or processes) disclosed in this application as relevant to any embodiment of the invention, and/or at least one signal resulting from one or any combination of methods (or processes) disclosed in this application as relevant to any embodiment of the invention.

In various example embodiments, the methods (or processes) can be accomplished on the service provider side or on the mobile device side or in any shared way between service provider and mobile device with actions being performed on both sides.

For various example embodiments, the following is applicable: An apparatus comprising means for performing the method of any of originally filed claims 1-10, 21-30, and 46-48.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of utilizing sensor data for auto bookmarking of information in one or more applications, according to an embodiment;

FIG. 2 is a diagram of the components of a user equipment capable of collection and analysis of sensor data for auto bookmarking of information, according to an embodiment;

FIGS. 3 through 5 are flowcharts of processes for, at least, utilizing sensor data for auto bookmarking of information in one or more applications, according to various embodiments;

FIG. 6 illustrates users and devices for implementing an auto bookmarking mechanism, according to an embodiment;

FIGS. 7 and 8 illustrate UI applications presenting bookmarkings, according to various embodiments;

FIG. 9 is a diagram of hardware that can be used to implement an embodiment of the invention;

FIG. 10 is a diagram of a chip set that can be used to implement an embodiment of the invention; and

FIG. 11 is a diagram of a mobile terminal (e.g., handset) that can be used to implement an embodiment of the invention.

### DESCRIPTION OF SOME EMBODIMENTS

Examples of a method, apparatus, and computer program for utilizing sensor data for auto bookmarking of information in one or more applications. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

The term “point of interest (POI)” and “geo-location” may be used interchangeably, according to some embodiments of the present invention, where a certain POI may be a certain object (e.g., a building, a banner, a restaurant, an establishment, etc.) at a certain geo-location and/or a geo-location may be a POI (e.g., an intersection at a given city, a street, an airport, etc.)

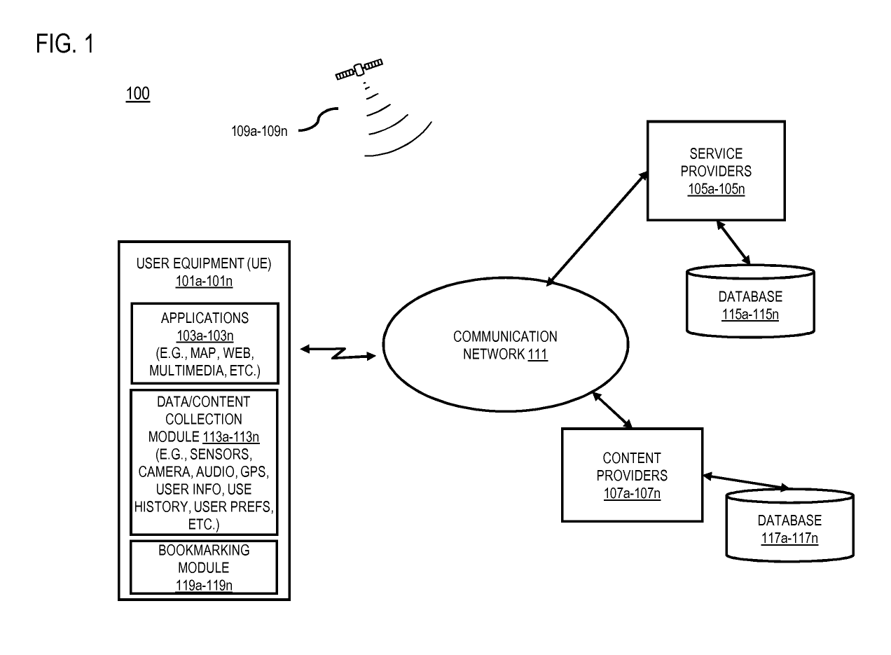

FIG. 1 is a diagram of a system capable of utilizing sensor data for auto bookmarking of information in one or more applications, according to an embodiment. As previously discussed, one area of interest has been development of services and technologies related to utilizing user devices (e.g., mobile phones, tablets, navigation systems, smart glasses/goggles/visors with sensors, etc.) including various sensors (e.g., global positioning system (GPS), camera, accelerometer, microphone, etc.) for capturing, processing, and/or storing (e.g., bookmarking) information and content (e.g., location information, speed, images, audio, etc.) associated with the devices and various items, objects, subjects, geo-locations (locations), POIs, and the like. For example, a process may include a user device (device) being utilized to capture an image of an object (e.g., a building, a billboard, a street sign, etc.), process the image to identify the object, and determine various information associated with the device and the object (e.g., location information, name, type of object, textual information, etc.) for storage and future reference/utilization (e.g., in a map application, in an Internet browser application, etc.) Generally, users may manually perform all or portions of said process, however, as the users may be multitasking (e.g., driving, taking photos, talking with someone, utilizing an application, etc.), they may not have enough time to notice, capture, and accurately store the information and the content for future reference. For instance, a user may be driving by a POI, for example a restaurant, that he sees for a first time, which he would like to visit in a near future, but as he is driving, he may not be able to quickly and accurately make a note of the location (e.g., bookmark), name, and/or other identifying information.

To address at least these problems, a system 100 of FIG. 1 introduces the capability for utilizing sensor data for auto bookmarking of information in one or more applications. In general, users utilize various devices having different capabilities, sensors, and applications for a range of services and processes (e.g., navigation, web browsing, content consumption, etc.), wherein the devices may be able to capture various sensor data; for example, multimedia, location information, directional information, accelerometer, and the like. However, as a user may utilize the devices, the applications, and/or the services under different circumstances, for example, while driving and/or passing-by a certain POI, the user may not be able to efficiently and/or accurately capture, store, and/or bookmark information and/or content items associated with the POI for possible future use and reference. In various embodiments, one or more sensors on one or more devices may capture sensor data (e.g., images, videos, location information, speed, direction, etc.) associated with various objects, subjects, POIs, etc. for processing and determining one or more associated information items. Further, one or more applications on the one or more devices and/or one or more service providers may store the sensor data and/or the information items as well as create one or more bookmarks in/for one or more applications (e.g., a mapping application, a web browser, etc.)

In one use case scenario, a user (e.g., a tourist) may be passing by a POI (e.g., a restaurant) and makes a mental note to visit the POI in a near future, however, does not make a note of any identifying information (e.g., name of the POI, address, etc.) and later, upon trying to locate the POI, he cannot recollect from memory. However, one embodiment of the system 100 would enable one or more applications of one or more user devices to capture one or more multimedia items of the POI, identify a subject/object in the multimedia items, determine one or more associated information items, and create one or more bookmarks in one or more applications for future reference.

In one embodiment, the system 100 processes and/or facilitates a processing of sensor data to determine one or more items at which at least one user is looking, one or more information items associated with the one or more items, or a combination thereof. In one embodiment, one or more devices within close proximity of one or more users may be utilized to determine viewing direction of the one or more users. For example, a user may be utilizing a head/body mounted device (e.g., Bluetooth® headset, glasses/goggles/visors, etc.) that includes various sensors, for example, camera, microphone, GPS, near field communication (NFC), motion detector, gyroscope, and the like. In one embodiment, the sensor data includes location information, head-tracking information, gaze-tracking information, physical movement information, one or more user gestures, or a combination thereof. For example, one or more cameras with two-dimensional and/or three-dimensional capabilities may capture and/or process image and/or data related to viewing point (e.g., gaze) associated with one or more users, for example, by closely monitoring eye movements and/or direction that the eye may be focused at. In one instance, the gaze tracking information may be captured and/or processed in conjunction with orientation and movement of a user's head. In one embodiment, a first device may be utilized to detect an object, a subject, a POI, a viewing point that the user may be looking at. For example, a gyroscope sensor in a device may detect a device movement (e.g., worn by the user, moved by the user, etc.) from one direction to another. In one embodiment, a user may point a device (e.g., a camera, a mobile phone, etc.) in a certain direction and/or at a certain object, subject, POI, and the like. In one embodiment, one or more devices may determine one or more viewing points, objects, subjects, POIs, and the like which a plurality of users in close proximity may be looking at. For example, several users may be in a close proximity (e.g., in a car, on a bus, on a train, walking nearby, etc.), wherein one or more devices may determine the viewing point of the plurality of the users. In one embodiment, one or more devices may share viewing information associated with a plurality of users with one or more other devices and/or service providers. For example, several users in a car may be utilizing glasses including various sensors, whereby the sensors may capture viewing information for each user and share that information with another device in close proximity (e.g., a mobile phone, a tablet, etc.) In various embodiments, the sensors available on a device may determine one or more information items associated with the one or more viewing points, objects, subjects, POIs, and the like. For example, the one or more information items may include, but not limited to, geo-location information, device information, user preferences, user mood, metadata associated with the object, subject, POI, a content item (e.g., an image of the POI, object, subject, etc.)

In one embodiment, the system 100 causes, at least in part, a bookmarking of the one or more items, the one or more information items, or a combination thereof in at least one application. I one embodiment, one or more modules and/or applications, for example, in a device and/or at a service provider may generate one or more bookmarkings for the one or more items and/or information items, and further, store/share/provide the one or more bookmarkings to one or more modules, one or more applications, one or more service providers, one or more devices, and the like. For example, a bookmarking may include location information of a POI (e.g., a restaurant) and one or more information items (e.g., type, category, rating, hours of operation, images, etc.), which may be provided to a mapping application, an Internet browsing application, a memory storage, etc.

In one embodiment, the system 100 causes, at least in part, a capture of at least one image of the one or more items. In one embodiment, an application and/or a module may cause a device to capture one or more media items (e.g., images, videos, audio recordings, etc.), which a user may be looking at. In one embodiment, a user may cause the device to capture the one or more media items.

In one embodiment, the system 100 causes, at least in part, a tagging of the at least one image with location information associated with at least one user determined at least substantially concurrently with the at least one user looking at the one or more items. In one embodiment, one or more applications and/or modules (e.g., on a device, at a service provider, etc.) may tag/mark/associate location information and/or other information items with one or more images of the one or more items (e.g., an object, a subject, a POI, etc.) that a user may be looking at, wherein the location information and the other information may be determined substantially concurrently as when the user is looking at the one or more items. For example, a user is looking at a building, a device determines that the user is looking at the building, captures an image of the building, determines location and other information of the building, and associates the information with the image for creating one or more bookmarkings.

In one embodiment, the system 100 determines that the sensor data indicates a movement of the at least one user above a threshold criterion. In one embodiment, one or more sensors on one or more devices may determine user directional and/or movement parameters, wherein the parameters may be compared to one or more threshold criteria (e.g., preset by a user, by one or more applications, by one or more modules, by a service provider, etc.). For example, the threshold criteria may include rotational degree, directional changes, viewing angle changes, sudden movements, changes in only certain parts of a user body (e.g., head, arm, hand, etc.) In one embodiment, one or more sensors may be worn on the body of a user, wherein the sensors may share each sensor data for determining the user movement.

In one embodiment, the system 100 causes, at least in part, an activation of at least one camera device for capturing the at least one image. In one embodiment, an application and/or a module on a device may utilize the sensor data associated with a user and/or a device movement to activate one or more camera devices (e.g., for imaging) and/or other multimedia sensors for capturing one or more images, videos, audio recordings, etc. In one embodiment, a first device may cause the activation of one or more camera devices on one or more other devices for the capturing of one or more images. For example, a mobile phone may cause a headset device to activate its camera.

In one embodiment, the system 100 processes at least one image, the sensor data, or a combination thereof to cause, at least in part, an identification of the one or more items, wherein the bookmarking is further based, at least in part, on the identification. In various embodiments, one or more applications and/or modules on one or more devices, service providers, and/or content providers process an image, a video, an audio recording, location information, and the like sensor information for identifying one or more objects, subjects, POIs, and/or items that one or more users may be looking at. For example, one or more image detection processes (e.g., algorithms, software, etc.) may be utilized to identify items/objects shown in an image, in a video capture, and the like. In one embodiment, one or more applications and/or module may utilize information from the identification of the one or more items to generate one or more bookmarkings. For example, an item in an image may be identified as being a certain antique shop at a certain geo-location, wherein the information associated with the antique shop may be used in generating a bookmark.

In one embodiment, the system 100 determines one or more neighboring items associated with the one or more items, wherein the bookmarking includes, at least in part, the one or more neighboring items, associated information, or a combination thereof. In various embodiments, the one or more applications and/or modules may determine and/or identify one or more neighboring items, in close proximity, of the one or more items, wherein information associated with the one or more neighboring items may be included in one or more bookmarks for the one or more items. In one embodiment, the information associated with the one or more neighboring items may be utilized to determine and/or identify the one or more items. For example, information of a first POI (e.g., a coffee shop) geo-located close to a second POI (e.g., a hair salon) may be utilized to identify the second POI, determine information associated with the second POI, and/or generate a bookmark for the second POI, wherein the bookmark may include one or more information items associated with the first POI.

In one embodiment, the system 100 determines at least one direction along which the at least one user is looking based, at least in part, on the sensor data. In one embodiment, one or more applications and/or modules may utilize data from one or more sensors at one or more devices to determine a user viewing point, viewing angle, focal point, viewing direction, and the like, wherein one or more data points from one or more sensors may be utilized. For example, sensor data from a gyroscope, a compass, and the like may be utilized. In one embodiment, the one or more sensors may be at one or more devices, whereby one or more of the devices and/or sensors may coordinate sharing, processing, and/or storage of the sensor data.

In one embodiment, the system 100 determines the one or more items based, at least in part, on the at least one direction. In one embodiment, the directional information from one or more sensors may be utilized to determine one or more items that one or more users may be looking at. For example, a compass direction, a GPS location, and/or a gyroscopic data may indicate user viewing direction, location of the user, and a viewing angle so that one or more items in focal point of the user may be determined. In one instance, the one or more directional and location information may be utilized to determine the one or more items from a database, a service provider, a content provider, and the like.

In one embodiment, the system 100 determines an input from the at least one user for specifying at least one search. In one embodiment, one or more applications may receive one or more inputs from one or more users for one or more search requests associated with one or more subjects, objects, items, POIs, and the like. Further, the one or more inputs may include various parameters associated with the one or more search requests, for example, location, category, subject type, user preferences, and the like. For example, a user may request a search on a certain type of restaurant, near a certain location, under a certain category, according to user preferences, etc., wherein the various parameters may be utilized to perform one or more searches at a user defined database, via one or more service providers, and the like.

In one embodiment, the system 100 determines at least one result for the at least one search based, at least in part, on the bookmarking. In one embodiment, one or more applications may access one or more bookmarks that may be stored in one or more modules, applications, data stores, service providers, and the like. For example, a map application may access bookmarks in one or more applications on a device for displaying one or more POIs on a map to a user. In various embodiments, one or more applications may utilize one or more bookmarks for web browsing, for navigation services, for content request and access, and the like.

In one embodiment, the system 100 determines at least one other user within proximity of the at least one user when performing the at least one search. In one embodiment, a plurality of devices may be with close proximity of each other, for example, in a car, in a bus, in a room, etc., wherein one or more devices and/or a service provider may determine the proximity of the devices when requesting and/or processing one or more search requests. For example, a first device may receive a search request from a first user, where the first device determines that there may be one or more other devices nearby, for example, via Bluetooth, radio frequency identification (RFID), wireless local area network (WLAN), and the like.

In one embodiment, the system 100 determines at least one other bookmarking based, at least in part, on sensor data associated with the at least one other user. In one embodiment, one or more applications and/or service providers may determine one or more sensor data associated with one or more other devices and/or users for generating one or more bookmarkings at one or more devices. For example, a first device may request and/or receive one or more sensor data from one or more other devices where the one or more sensor data may be utilized with or without sensor data from the first device for generating one or more bookmarkings.

In one embodiment, the system 100 determines the at least one result, a weighting of the at least one result, or a combination thereof based, at least in part, on the at least one other bookmarking. In one embodiment, one or more applications, modules, and/or service providers may determine and/or associate one or more weights with one or more results based on one or more bookmarkings from one or more other devices. For example, a bookmark available on a plurality of devices may have a higher weighting (e.g., higher priority). In one embodiment, search results (e.g., for a POI) on a first device may be determined by utilizing one or more bookmarkings from one or more other devices. For example, the first device may request and/or access a bookmarking from another device for presenting a search result to a user of the first device.

In one embodiment, the system 100 causes, at least in part, a presentation of content information associated with the one or more items to the at least one user. In various embodiments, one or more applications, service and/or content providers may determine and present to a user one or more content and/or information associated with one or more items, objects, subjects, etc. that one or more users may be looking at. For example, a user may be looking at a restaurant establishment where a service provider may present various information items related to the restaurant, for example, images of interior space, types of food served, ratings, pricing, reservation information, coupons, operating information, and the like. In one embodiment, the content and/or the information may be determined from one or more other device in close proximity to a first device.

As discussed above, the system 100 may provide various benefits and advantages to the users utilizing the methods of the system 100. For example, the system 100, at least, provides an efficient mechanism for substantially automatically capturing, processing, and/or determining information associated with user viewing point and subjects for generating bookmarking, wherein the bookmarkings may be utilized by various applications, devices, users, service providers, content providers, and the like for requesting and/or providing various information and/or services based, at least in part, on the bookmarkings.

As shown in FIG. 1, in one embodiment, the system 100 includes user equipment (UE) 101a-101n (also collectively referred to as UE 101 and/or UEs 101), which may be utilized to execute one or more applications 103a-103n (also collectively referred to as applications 103) including social networking, web browser, multimedia applications, user interface (UI), map application, web client, etc. to communicate with other UEs 101, one or more service providers 105a-105n (also collectively referred to as service providers 105), one or more content providers 107a-107n (also collectively referred to as content providers 107), one or more GPS satellites 109a-109n (also collectively referred to as GPS satellites 109), and/or with other components of the system 100 directly and/or via communication network 111. In one embodiment, the UEs 101 may include data/content collection modules 113a-113n (also collectively referred to as DC collection module 113) for determining and/or collecting data and/or content associated with the UEs 101, one or more users of the UEs 101, applications 103, one or more content items (e.g., multimedia content), and the like.

In one embodiment, the UEs 101 may include bookmarking modules 119a-119n (also collectively referred to as bookmarking module 119) for determining and/or generating one or more bookmarks associated with one or more POIs, content items, geo-locations, and the like, wherein the bookmarks may be stored at and/or utilized by the UEs 101, the applications 103, the service providers 105, and the like. For example, a bookmark may be associated with a certain POI, a geo-location, a tag, and/or various information items, wherein the bookmark may be stored at a UE 101 (e.g., memory, in one or more applications, etc.) and/or at the service providers 105 (e.g., cloud services) for utilization by various applications, service providers, content providers, for example, a mapping application, an Internet browser, a navigation application/service, and the like. Further, the bookmarking module 119 may interact with the applications 103, other modules of a UE 101, and/or a user to for performing one or more tasks/functions in order to determine content and information to be utilized for generating the various bookmarks. In one embodiment, the bookmarking module 119 may determine if a bookmark and associated information may be applicable to one or more applications and/or services. In certain embodiments, the bookmarking module 119 is implemented as a collection of one or more hardware, software, algorithms, firmware, or combinations thereof that can be integrated for use with the service providers 105 and/or with the content providers 107. In addition, the UEs 101 can execute an application 103 that is a software client for storing, processing, and/or forwarding one or more information items to other components of the system 100.

The UEs 101 may be any type of mobile terminal, fixed terminal, or portable terminal including a mobile handset, station, unit, device, healthcare diagnostic and testing devices, product testing devices, multimedia computer, glasses/goggles/visors including sensors, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, loud speakers, display monitors, radio broadcast receiver, electronic book device, game device, wrist watch, or any combination thereof, including the accessories and peripherals of these devices, or any combination thereof. It is also contemplated that the UEs can support any type of interface to the user (such as “wearable” circuitry, etc.) Further, the UEs 101 may include various sensors for collecting data associated with a user, a user's environment, and/or with a UE 101, for example, the sensors may determine and/or capture audio, video, images, atmospheric conditions, device location, user mood, ambient lighting, device movement speed and direction, and the like.

In one embodiment, the UE 101 includes a location module/sensor that can determine the UE 101 location (e.g., a user's location). The UE 101 location may be determined by a triangulation system such as a GPS, assisted GPS (A-GPS), Cell of Origin, wireless local area network triangulation, or other location extrapolation technologies. Standard GPS and A-GPS systems can use the one or more satellites 109 to pinpoint the location (e.g., longitude, latitude, and altitude) of the UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module/sensor may also utilize multiple technologies to detect the location of the UE 101. GPS coordinates can provide finer detail as to the location of the UE 101. In another embodiment, the UE 101 may utilize a local area network (e.g., LAN, WLAN) connection to determine the UE 101 location information, for example, from an Internet source (e.g., a service provider).

By way of example, the communication network 111 of system 100 includes one or more networks such as a data network, a wireless network, a telephony network, or any combination thereof It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

In one embodiment, the service providers 105 may include and/or have access to one or more database 115a-115n (also collectively referred to as database 115), which may include various user information, user profiles, user preferences, one or more profiles of one or more user devices (e.g., device configuration, sensors information, etc.), service providers 105 information, other service providers' information, and the like. In one embodiment, the service providers 105 may include one or more service providers offering one or more services, for example, online shopping, location-based services, navigation services, social networking services (e.g., blogging), media upload, media download, media streaming, account management services, or a combination thereof Further, the service providers 105 may conduct a search for content items, media items, information, coupons, and the like associated with one or more users, POIs, geo-locations, and the like.

In one embodiment, the content providers 107 may include and/or have access to one or more database 117a-117n (also collectively referred to as database 117), which may store, include, and/or have access to various content items. For example, the content providers 107 may store content items (e.g., at the database 117) provided by various users, various service providers, crowd-sourced content, and the like. In various embodiments, the content providers 107 may sort, manage, store, and/or make the content items available based on various parameters, for example, geo-location information (e.g., of a submitter, of a content item, of a requestor, of a POI, etc.), sequential order, content type (e.g., audio, video, still images, etc.), date/time of content creation and/or submission, date/time of a content request, and the like. In various embodiments, the content may include media items, maps, metadata (e.g., geo-location information, content type, content creator, etc.) associated with the content items, various POIs, and the like.

In various embodiments, the bookmarking module 119 may operate on a UE 101 in cooperation with the applications 103 in connection with the service providers 105 and/or with the content providers 107 as an extensible feature, a web-service, an applet, a script, an object-oriented application, or the like to enable processing, analyzing, detecting, and the like, of content items (e.g., audio, video, image, text, etc.), metadata, and the like for bookmarking and other processes and applications. Further, the bookmarking module 119, the service providers 105, and/or the content providers 107 may utilize one or more service application programming interfaces (APIs)/integrated interface, through which communication, media, content, and information (e.g., associated with users and services, content, POIs, bookmarks, etc.) may be shared, accessed and/or processed.

By way of example, the UEs 101, the service providers 105 and the content providers 107 may communicate with each other and other components of the communication network 111 using well known, new or still developing protocols. In this context, a protocol includes a set of rules defining how the network nodes within the communication network 111 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application (layer 5, layer 6 and layer 7) headers as defined by the OSI Reference Model.

In one embodiment, the UEs 101 and the service providers 105 may interact according to a client-server model. It is noted that the client-server model of computer process interaction is widely known and used. According to the client-server model, a client process sends a message including a request to a server process, and the server process responds by providing a service. The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others. It is also noted that the role of a client and a server is not fixed; in some situations a device may act both as a client and a server, which may be done simultaneously and/or the device may alternate between these roles.

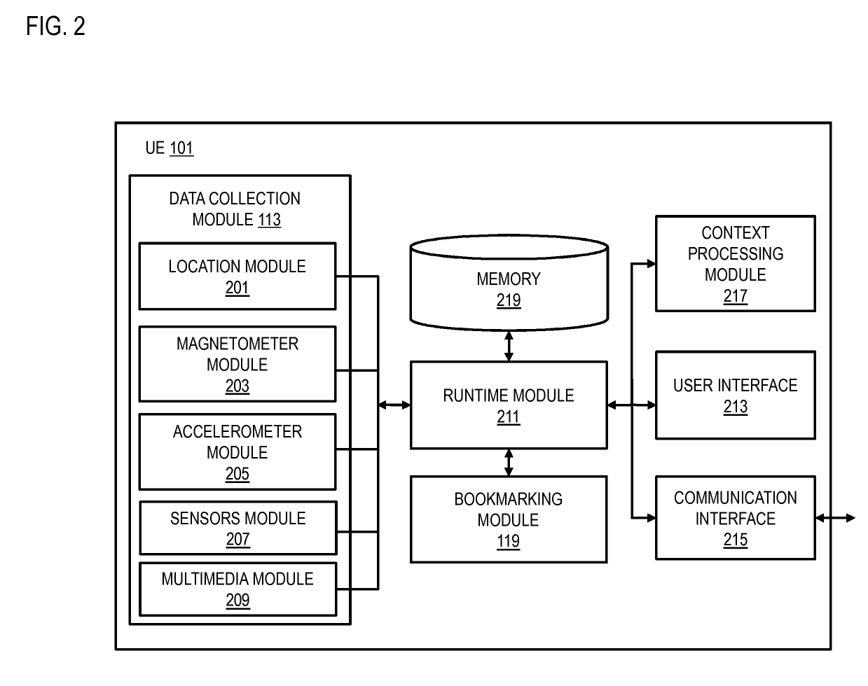

FIG. 2 is a diagram of the components of a user equipment capable of collection and analysis of sensor data for auto bookmarking of information, according to an embodiment. By way of example, a UE 101 includes one or more components for collecting and analyzing sensor data for auto bookmarking of information in various applications. It is contemplated that the functions of these components may be combined in one or more components or performed by other components of equivalent functionality. In this embodiment, the UE 101 includes a DC collection module 113 that may include one or more location modules 201, magnetometer modules 203, accelerometer modules 205, sensors module 207, and multimedia module 209. Further, the UE 101 may also include a runtime module 211 to coordinate the use of other components of the UE 101, the bookmarking module 119, a user interface 213, a communication interface 215, a context processing module 217, and memory 219. The applications 103 of the UE 101 can execute on the runtime module 211 utilizing the components of the UE 101.

The location module 201 can determine a user's location, for example, via location of a UE 101. The user's location can be determined by a triangulation system such as GPS, assisted GPS (A-GPS), Cell of Origin, or other location extrapolation technologies. Standard GPS and A-GPS systems can use satellites 109 to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 201 may also utilize multiple technologies to detect the location of the UE 101. Location coordinates (e.g., GPS coordinates) can give finer detail as to the location of the UE 101 when media is captured. In one embodiment, GPS coordinates are stored as context information in the memory 219 and are available to the context processing module 217, the DC collection module 113, the service providers 105, and/or to other entities of the system 100 (e.g., via the communication interface 215.) Moreover, in certain embodiments, the GPS coordinates can include an altitude to provide a height. In other embodiments, the altitude can be determined using another type of altimeter. In certain embodiments, the location module 201 can be a means for determining a location of the UE 101, an image, or used to associate an object in view with a location.

The magnetometer module 203 can be used in finding horizontal orientation of the UE 101. A magnetometer is an instrument that can measure the strength and/or direction of a magnetic field. Using the same approach as a compass, the magnetometer is capable of determining the direction of a UE 101 using the magnetic field of the Earth. The front of a media capture device (e.g., a camera) can be marked as a reference point in determining direction. Thus, if the magnetic field points north compared to the reference point, the angle the UE 101 reference point is from the magnetic field is known. Simple calculations can be made to determine the direction of the UE 101. In one embodiment, horizontal directional data obtained from a magnetometer can be stored in memory 219, made available to other modules and/or applications 103 of the UE 101, and/or transmitted via the communication interface 215 to one or more entities of the system 100.

The accelerometer module 205 can be used to determine vertical orientation of the UE 101. An accelerometer is an instrument that can measure acceleration. Using a three-axis accelerometer, with axes X, Y, and Z, provides the acceleration in three directions with known angles. Once again, the front of a media capture device can be marked as a reference point in determining direction. Because the acceleration due to gravity is known, when a UE 101 is stationary, the accelerometer module 205 can determine the angle the UE 101 is pointed as compared to Earth's gravity. In certain embodiments, the magnetometer module 203 and accelerometer module 205 can be means for ascertaining a perspective of a user. This perspective information may be stored in the memory 219, made available to other modules and/or applications 103 of the UE 101, and/or sent to one or more entities of the system 100.

In various embodiments, the sensors module 207 can process sensor data from various sensors (e.g., GPS, accelerometer, gyroscope, thermometer, etc.) to determine environmental (e.g., atmospheric) conditions surrounding the UE 101, user mood (e.g., hungry, angry, tired, etc.), location information, and various other information from a range sensors that may be available on one or more devices. For example, the sensors module 207 may detect conditions including humidity, temperature, geo-location, biometric data of the user, etc. Once again, this information can be stored in the memory 219 and sent to the context processing module 217 and/or to other entities of the system 100. In certain embodiments, information collected from the DC collection module 113 can be retrieved by the runtime module 211 and stored in memory 219, made available to other modules and/or applications 103 of the UE 101, and/or sent to one or more entities of the system 100.

In one embodiment, the multimedia module 209 may be utilized to capture various media items, for example, images, video, audio, and the like, wherein the captured media may be submitted to one or more modules and applications of the UE 101, a service provider, and/or a content provider to further processing, storage, sharing, and the like. For example, a captured image of a POI (e.g., a building) may be submitted to the context processing module 217 for analysis and correlation to one or more information items (e.g., metadata), for example, geo-location information, textual information, POI category type, and the like.

In one embodiment, the communication interface 215 can be used to communicate with one or more entities of the system 100. Certain communications can be via methods such as an internet protocol, messaging (e.g., SMS, MMS, etc.), or any other communication method (e.g., via the communication network 111). In some examples, the UE 101 can send context information associated with the UE 101 to the service providers 105, content providers 107, and/or to other entities of the system 100.

The user interface 213 can include various methods of communication. For example, the user interface 213 can have outputs including a visual component (e.g., a screen), an audio component, a physical component (e.g., vibrations), and other methods of communication. User inputs can include a touch-screen interface, a scroll-and-click interface, a button interface, a microphone, etc. Input can be via one or more methods such as voice input, textual input, typed input, typed touch-screen input, other touch-enabled input, etc.

The context processing module 217 may be utilized in determining context information from the DC collection module 113 and/or applications 103 executing on the runtime module 211. This information may be caused to be transmitted, via the communication interface 215, to the service providers 105 and/or to other entities of the system 100. The context processing module 217 may additionally be utilized as a means for determining information related to the user, an instance of data, a value, a content item, an object, a subject, and the like. In certain embodiments, the context processing module 217 can infer higher level context information from the context data such as favorite locations, significant places, common activities, interests in products and services, POIs at various geo-locations, etc.

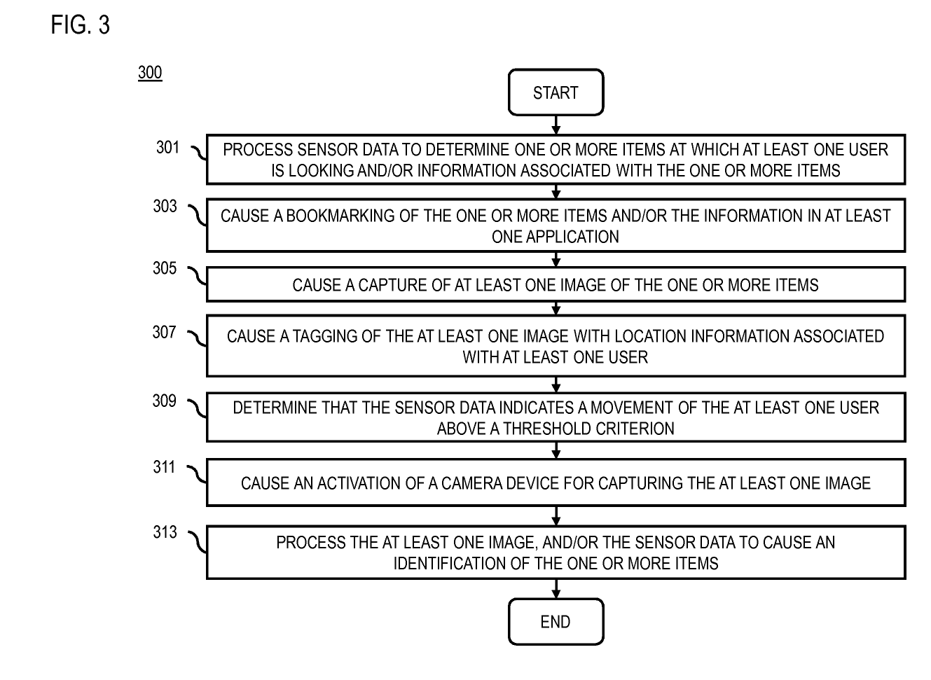

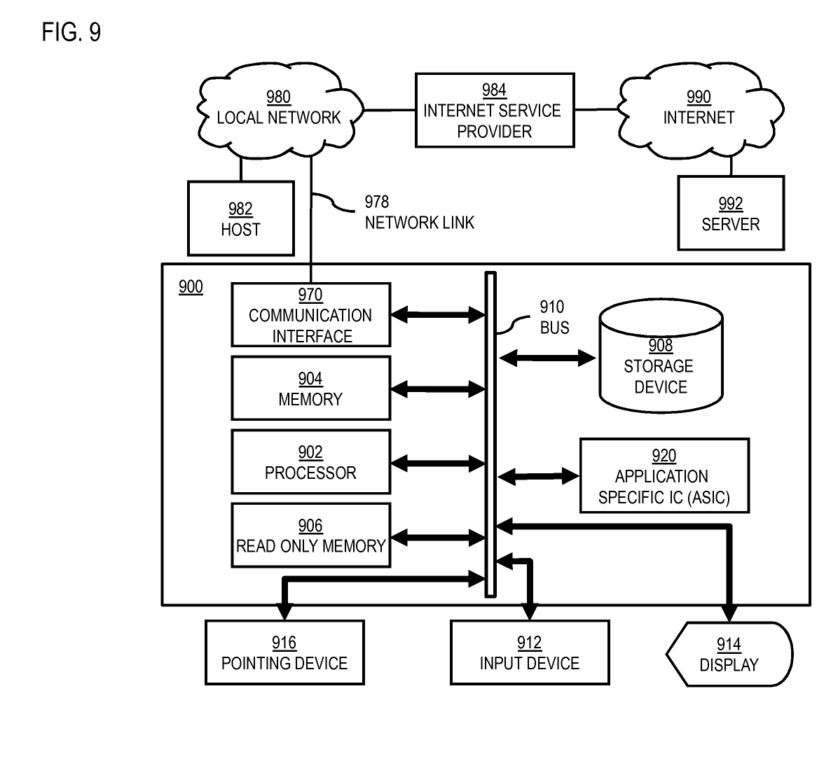

FIG. 3 is a flowchart of a process for, at least, determining subjects that a user may be looking at for causing one or more bookmarkings, according to various embodiments. In various embodiments, the bookmarking module 119 may perform the process 300 and may be implemented in, for instance, a chip set including a processor and a memory as shown in FIG. 9. Further, the bookmarking module 119, the service providers 105, the content providers 107, and/or the UEs 101 can provide means for accomplishing various parts of the process 300 as well as means for accomplishing other processes in conjunction with other components of the system 100. Throughout this process, bookmarking module 119 is referred to as completing various portions of the process 300, however, it is understood that other components of the system 100 can perform some of and/or all of the process steps. Further, in various embodiments, the bookmarking module 119 may be implemented in one or more entities of the system 100.

In step 301, the bookmarking module 119 processes and/or facilitates a processing of sensor data to determine one or more items at which at least one user is looking, one or more information items associated with the one or more items, or a combination thereof. In one embodiment, one or more devices within close proximity of one or more users may be utilized to determine viewing direction of the one or more users. For example, a user may be utilizing a head/body mounted device (e.g., Bluetooth® headset, glasses/goggles/visors, etc.) that includes various sensors, for example, camera, microphone, GPS, near field communication (NFC), motion detector, gyroscope, and the like. In one embodiment, the sensor data includes location information, head-tracking information, gaze-tracking information, physical movement information, one or more user gestures, or a combination thereof. For example, one or more cameras with two-dimensional and/or three-dimensional capabilities may capture and/or process image and/or data related to viewing point (e.g., gaze) associated with one or more users, for example, by closely monitoring eye movements and/or direction that the eye may be focused at. In one instance, the gaze tracking information may be captured and/or processed in conjunction with orientation and movement of a user's head. In one embodiment, a first device may be utilized to detect an object, a subject, a POI, a viewing point that the user may be looking at. For example, a gyroscope sensor in a device may detect a device movement (e.g., worn by the user, moved by the user, etc.) from one direction to another. In one embodiment, a user may point a device (e.g., a camera, a mobile phone, etc.) in a certain direction and/or at a certain object, subject, POI, and the like. In one embodiment, one or more devices may determine one or more viewing points, objects, subjects, POIs, and the like which a plurality of users in close proximity may be looking at. For example, several users may be in a close proximity (e.g., in a car, on a bus, on a train, walking nearby, etc.), wherein one or more devices may determine the viewing point of the plurality of the users. In one embodiment, one or more devices may share viewing information associated with a plurality of users with one or more other devices and/or service providers. For example, several users in a car may be utilizing glasses including various sensors, whereby the sensors may capture viewing information for each user and share that information with another device in close proximity (e.g., a mobile phone, a tablet, etc.) In various embodiments, the sensors available on a device may determine one or more information items associated with the one or more viewing points, objects, subjects, POIs, and the like. For example, the one or more information items may include, but not limited to, geo-location information, device information, user preferences, user mood, metadata associated with the object, subject, POI, a content item (e.g., an image of the POI, object, subject, etc.)

In step 303, the bookmarking module 119 causes, at least in part, a bookmarking of the one or more items, the one or more information items, or a combination thereof in at least one application. I one embodiment, one or more modules and/or applications, for example, in a device and/or at a service provider may generate one or more bookmarkings for the one or more items and/or information items, and further, store/share/provide the one or more bookmarkings to one or more modules, one or more applications, one or more service providers, one or more devices, and the like. For example, a bookmarking may include location information of a POI (e.g., a restaurant) and one or more information items (e.g., type, category, rating, hours of operation, images, etc.), which may be provided to a mapping application, an Internet browsing application, a memory storage, etc.

In step 305, the bookmarking module 119 causes, at least in part, a capture of at least one image of the one or more items. In one embodiment, an application and/or a module may cause a device to capture one or more media items (e.g., images, videos, audio recordings, etc.), which a user may be looking at. In one embodiment, a user may cause the device to capture the one or more media items.

In step 307, the bookmarking module 119 causes, at least in part, a tagging of the at least one image with location information associated with at least one user determined at least substantially concurrently with the at least one user looking at the one or more items. In one embodiment, one or more applications and/or modules (e.g., on a device, at a service provider, etc.) may tag/mark/associate location information and/or other information items with one or more images of the one or more items (e.g., an object, a subject, a POI, etc.) that a user may be looking at, wherein the location information and the other information may be determined substantially concurrently as when the user is looking at the one or more items. For example, a user is looking at a building, a device determines that the user is looking at the building, captures an image of the building, determines location and other information of the building, and associates the information with the image for creating one or more bookmarkings.

In step 309, the bookmarking module 119 determines that the sensor data indicates a movement of the at least one user above a threshold criterion. In one embodiment, one or more sensors on one or more devices may determine user directional and/or movement parameters, wherein the parameters may be compared to one or more threshold criteria (e.g., preset by a user, by one or more applications, by one or more modules, by a service provider, etc.). For example, the threshold criteria may include rotational degree, directional changes, viewing angle changes, sudden movements, changes in only certain parts of a user body (e.g., head, arm, hand, etc.) In one embodiment, one or more sensors may be worn on the body of a user, wherein the sensors may share each sensor data for determining the user movement.

In step 311, the bookmarking module 119 causes, at least in part, an activation of at least one camera device for capturing the at least one image. In one embodiment, an application and/or a module on a device may utilize the sensor data associated with a user and/or a device movement to activate one or more camera devices (e.g., for imaging) and/or other multimedia sensors for capturing one or more images, videos, audio recordings, etc. In one embodiment, a first device may cause the activation of one or more camera devices on one or more other devices for the capturing of one or more images. For example, a mobile phone may cause a headset device to activate its camera.

In step 313, the bookmarking module 119 processes at least one image, the sensor data, or a combination thereof to cause, at least in part, an identification of the one or more items, wherein the bookmarking is further based, at least in part, on the identification. In various embodiments, one or more applications and/or modules on one or more devices, service providers, and/or content providers process an image, a video, an audio recording, location information, and the like sensor information for identifying one or more objects, subjects, POIs, and/or items that one or more users may be looking at. For example, one or more image detection processes (e.g., algorithms, software, etc.) may be utilized to identify items/objects shown in an image, in a video capture, and the like. In one embodiment, one or more applications and/or module may utilize information from the identification of the one or more items to generate one or more bookmarkings. For example, an item in an image may be identified as being a certain antique shop at a certain geo-location, wherein the information associated with the antique shop may be used in generating a bookmark.

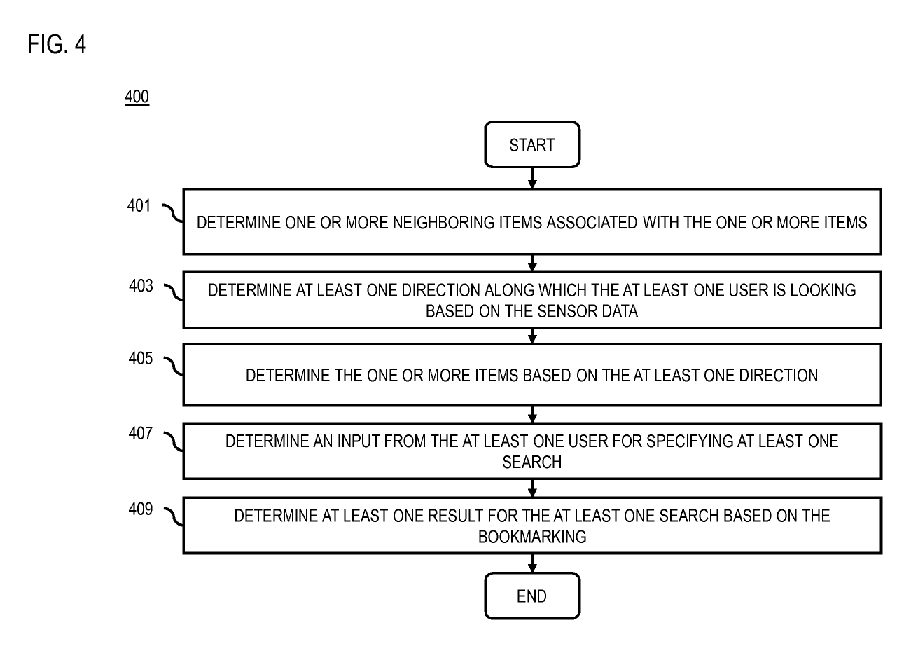

FIG. 4 is a flowchart of a process for, at least, determining neighboring subjects that a user may be looking at for causing one or more bookmarkings, according to various embodiments. In various embodiments, the bookmarking module 119 may perform the process 400 and may be implemented in, for instance, a chip set including a processor and a memory as shown in FIG. 9. Further, the bookmarking module 119, the service providers 105, the content providers 107, and/or the UEs 101 can provide means for accomplishing various parts of the process 400 as well as means for accomplishing other processes in conjunction with other components of the system 100. Throughout this process, bookmarking module 119 is referred to as completing various portions of the process 400, however, it is understood that other components of the system 100 can perform some of and/or all of the process steps. Further, in various embodiments, the bookmarking module 119 may be implemented in one or more entities of the system 100.

In step 401, the bookmarking module 119 determines one or more neighboring items associated with the one or more items, wherein the bookmarking includes, at least in part, the one or more neighboring items, associated information, or a combination thereof. In various embodiments, the one or more applications and/or modules may determine and/or identify one or more neighboring items, in close proximity, of the one or more items, wherein information associated with the one or more neighboring items may be included in one or more bookmarks for the one or more items. In one embodiment, the information associated with the one or more neighboring items may be utilized to determine and/or identify the one or more items. For example, information of a first POI (e.g., a coffee shop) geo-located close to a second POI (e.g., a hair salon) may be utilized to identify the second POI, determine information associated with the second POI, and/or generate a bookmark for the second POI, wherein the bookmark may include one or more information items associated with the first POI.

In step 403, the bookmarking module 119 determines at least one direction along which the at least one user is looking based, at least in part, on the sensor data. In one embodiment, one or more applications and/or modules may utilize data from one or more sensors at one or more devices to determine a user viewing point, viewing angle, focal point, viewing direction, and the like, wherein one or more data points from one or more sensors may be utilized. For example, sensor data from a gyroscope, a compass, and the like may be utilized. In one embodiment, the one or more sensors may be at one or more devices, whereby one or more of the devices and/or sensors may coordinate sharing, processing, and/or storage of the sensor data.

In step 405, the bookmarking module 119 determines the one or more items based, at least in part, on the at least one direction. In one embodiment, the directional information from one or more sensors may be utilized to determine one or more items that one or more users may be looking at. For example, a compass direction, a GPS location, and/or a gyroscopic data may indicate user viewing direction, location of the user, and a viewing angle so that one or more items in focal point of the user may be determined. In one instance, the one or more directional and location information may be utilized to determine the one or more items from a database, a service provider, a content provider, and the like.

In step 407, the bookmarking module 119 determines an input from the at least one user for specifying at least one search. In one embodiment, one or more applications may receive one or more inputs from one or more users for one or more search requests associated with one or more subjects, objects, items, POIs, and the like. Further, the one or more inputs may include various parameters associated with the one or more search requests, for example, location, category, subject type, user preferences, and the like. For example, a user may request a search on a certain type of restaurant, near a certain location, under a certain category, according to user preferences, etc., wherein the various parameters may be utilized to perform one or more searches at a user defined database, via one or more service providers, and the like.

In step 409, the bookmarking module 119 determines at least one result for the at least one search based, at least in part, on the bookmarking. In one embodiment, one or more applications may access one or more bookmarks that may be stored in one or more modules, applications, data stores, service providers, and the like. For example, a map application may access bookmarks in one or more applications on a device for displaying one or more POIs on a map to a user. In various embodiments, one or more applications may utilize one or more bookmarks for web browsing, for navigation services, for content request and access, and the like.

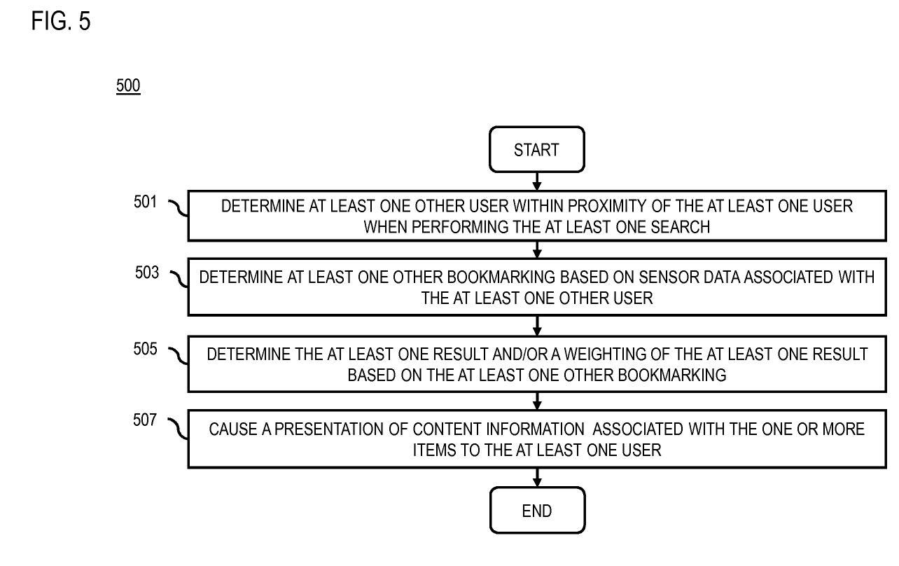

FIG. 5 is a flowchart of a process for, at least, determining various users in close proximity, according to various embodiments. In various embodiments, the bookmarking module 119 may perform the process 500 and may be implemented in, for instance, a chip set including a processor and a memory as shown in FIG. 9. Further, the bookmarking module 119, the service providers 105, the content providers 107, and/or the UEs 101 can provide means for accomplishing various parts of the process 500 as well as means for accomplishing other processes in conjunction with other components of the system 100. Throughout this process, bookmarking module 119 is referred to as completing various portions of the process 500, however, it is understood that other components of the system 100 can perform some of and/or all of the process steps. Further, in various embodiments, the bookmarking module 119 may be implemented in one or more entities of the system 100.

In step 501, the bookmarking module 119 determines at least one other user within proximity of the at least one user when performing the at least one search. In one embodiment, a plurality of devices may be with close proximity of each other, for example, in a car, in a bus, in a room, etc., wherein one or more devices and/or a service provider may determine the proximity of the devices when requesting and/or processing one or more search requests. For example, a first device may receive a search request from a first user, where the first device determines that there may be one or more other devices nearby, for example, via Bluetooth, radio frequency identification (RFID), wireless local area network (WLAN), and the like.

In step 503, the bookmarking module 119 determines at least one other bookmarking based, at least in part, on sensor data associated with the at least one other user. In one embodiment, one or more applications and/or service providers may determine one or more sensor data associated with one or more other devices and/or users for generating one or more bookmarkings at one or more devices. For example, a first device may request and/or receive one or more sensor data from one or more other devices where the one or more sensor data may be utilized with or without sensor data from the first device for generating one or more bookmarkings.

In step 505, the bookmarking module 119 determines the at least one result, a weighting of the at least one result, or a combination thereof based, at least in part, on the at least one other bookmarking. In one embodiment, one or more applications, modules, and/or service providers may determine and/or associate one or more weights with one or more results based on one or more bookmarkings from one or more other devices. For example, a bookmark available on a plurality of devices may have a higher weighting (e.g., higher priority). In one embodiment, search results (e.g., for a POI) on a first device may be determined by utilizing one or more bookmarkings from one or more other devices. For example, the first device may request and/or access a bookmarking from another device for presenting a search result to a user of the first device.

In step 507, the bookmarking module 119 causes, at least in part, a presentation of content information associated with the one or more items to the at least one user. In various embodiments, one or more applications, service and/or content providers may determine and present to a user one or more content and/or information associated with one or more items, objects, subjects, etc. that one or more users may be looking at. For example, a user may be looking at a restaurant establishment where a service provider may present various information items related to the restaurant, for example, images of interior space, types of food served, ratings, pricing, reservation information, coupons, operating information, and the like. In one embodiment, the content and/or the information may be determined from one or more other device in close proximity to a first device.

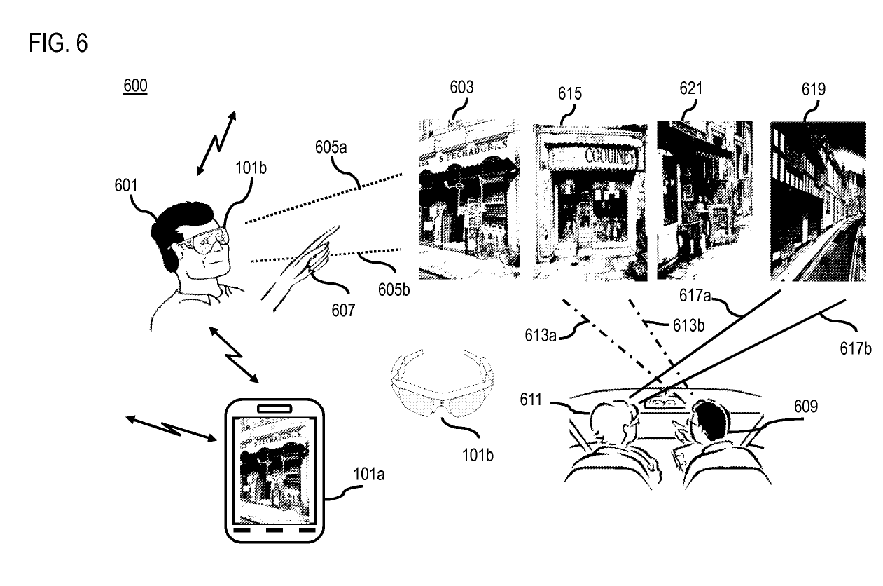

FIG. 6 illustrates users and devices for implementing an auto bookmarking mechanism, according to an embodiment. In FIG. 6, diagram 600 includes user 601 utilizing devices UE 101a and a UE 101b, for example, a mobile phone 101a and a pair of goggles/glasses 101b, wherein the devices may utilize various sensors including GPS, gyroscope, accelerometer, compass, cameras, microphones, and the like. In one embodiment, the UEs 101a and 101b may communicate with each other via various communication links for sharing various sensor data, for example, images, audio, video, location information, and the like. Further, the UEs 101a and 101b may directly and/or via one or more other devices communicate with one or more service providers, content providers, and/or other entities of the system 100, for example, to share the one or more sensor data. Furthermore, the UEs 101a and 101b may communicate and/or share one or more sensor data with one or more other devices (e.g., nearby devices, remote devices, etc.) In one use case scenario, the user 601 is looking at subject 603 (e.g., a shop) while wearing the UE 101b, wherein one or more sensors on the UEs 101a and 101b determine the user 601 viewpoint is at the establishment 603. In one embodiment, the UE 101b determines a viewing/gaze direction between indicators 605a and 605b via one or more sensors on the UEs 101a and/or 101b for determining the focal point being at the subject 603. In one embodiment, the UE 101a and/or the UE 101b may cause one or more cameras on the UEs 101a and/or the UE 101b to capture one or more images of the subject 604, wherein one or more other sensors of either of the UEs may capture one or more other information items; for example, location information, time, date, and the like which may be associated with the one or more captured images. In one embodiment, the UEs 101a and 101b may submit the one or more images and sensor data to one or more service providers for identification of one or more subjects included in the one or more images. In one embodiment, the user 601 may indicate a focal point by, for example, pointing to the subject 603 by using the user hand 607 and/or other objects, wherein the UEs 101a and 101b may detect the pointing action in the viewing direction between the indictors 605a and 605b. In one embodiment, the UEs 101a and/or 101b may utilize one or more information items associated with the subject 603 to generate one or more bookmarkings via one or more applications, modules, service providers, and the like, wherein the bookmarkings may be utilized by one or more devices, service providers, content providers, and the like.

The diagram 600 also depicts a plurality of users, for example, 609 and 611 (e.g., in a car) where the users may be utilizing various UEs 101. In one example, the viewing direction of the user 609 may be determined to be within indicators and a focal point at subject 615 and the viewing direction of the user 611 is determined to be within indicators 617a and 671b with a focal point at subject 619. In various embodiments, the UEs of the users 609 and 611 may collaborate with each other on any of steps for determining sensor data, subjects, and associated information for generating one or more bookmarkings. In one embodiment, an image and sensor data associated with a neighboring subject near/next to a subject determined to be the focal point of a user may also be captured, for example, to be utilized as an additional reference point for identifying a subject that a user may be looking at and may be interested in generating a bookmarking for. In one example, subject 621 may be captured as a neighboring subject for the subjects 615 and/or 619. In one embodiment, if sensor data associated with a certain subject (e.g., 615) is missing one or more information items, sensor data associated with a neighboring subject (e.g., 621 and/or 603) may be utilized to determine the missing one or more information items.

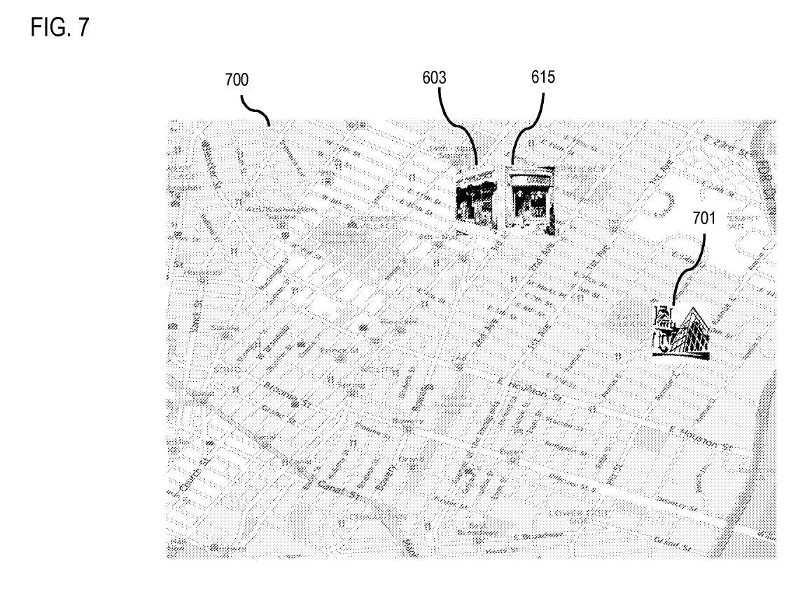

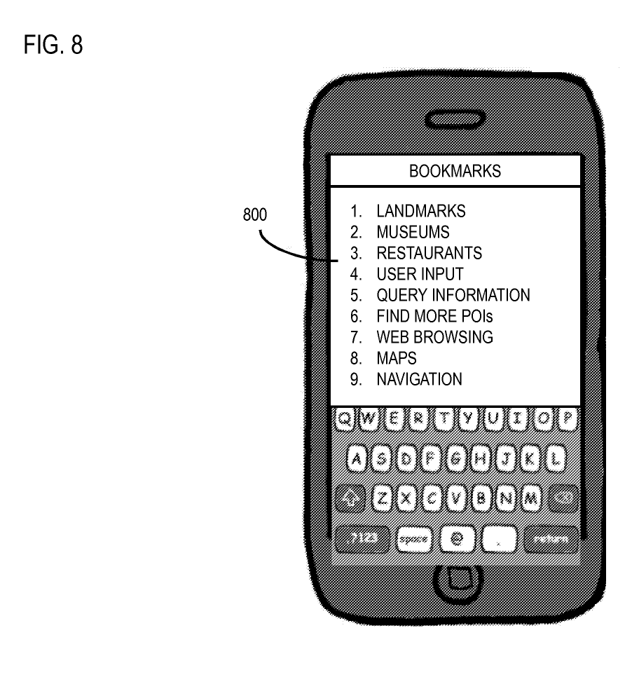

FIGS. 7 and 8 illustrate UI applications presenting bookmarkings, according to various embodiments. In FIG. 7, a UI 700 includes a mapping application wherein one or more bookmarkings 603, 615, and 701 are presented at a UE 101. For example, a user may utilize one or more applications on one or more devices to access one or more bookmarkings from one or more devices, wherein additional information (e.g., advertising, coupons, etc.) associated with the bookmarkings may be presented to the user by one or more service providers and/or content providers. In FIG. 8, a UI 800 presents a list of bookmarkings which may be accessed by one or more applications, for example the mapping application 700, for utilization by a user. In various embodiments, the bookmarkings may be stored locally at a device, at a service provider (e.g., cloud service), at another device, and the like. In one embodiment, a user may utilize the UI 800 to input one or more search requests for one or more items, subjects, associated information, and the like.

The processes described herein for efficiently utilizing sensor data for auto bookmarking of information in one or more applications may be advantageously implemented via software, hardware, firmware, or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

FIG. 9 illustrates a computer system 900 upon which an embodiment of the invention may be implemented. Although computer system 900 is depicted with respect to a particular device or equipment, it is contemplated that other devices or equipment (e.g., network elements, servers, etc.) within FIG. 910 can deploy the illustrated hardware and components of system 900. Computer system 900 is programmed (e.g., via computer program code or instructions) to efficiently utilizing sensor data for auto bookmarking of information in one or more applications as described herein and includes a communication mechanism such as a bus 910 for passing information between other internal and external components of the computer system 900. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 900, or a portion thereof, constitutes a means for performing one or more steps of efficiently utilizing sensor data for auto bookmarking of information in one or more applications.

A bus 910 includes one or more parallel conductors of information so that information is transferred quickly among devices coupled to the bus 910. One or more processors 902 for processing information are coupled with the bus 910.

A processor (or multiple processors) 902 performs a set of operations on information as specified by computer program code related to efficiently utilize sensor data for auto bookmarking of information in one or more applications. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 910 and placing information on the bus 910. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 902, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 900 also includes a memory 904 coupled to bus 910. The memory 904, such as a random access memory (RAM) or any other dynamic storage device, stores information including processor instructions for efficiently utilizing sensor data for auto bookmarking of information in one or more applications. Dynamic memory allows information stored therein to be changed by the computer system 900. RAM allows a unit of information stored at a location called a memory address to be stored and retrieved independently of information at neighboring addresses. The memory 904 is also used by the processor 902 to store temporary values during execution of processor instructions. The computer system 900 also includes a read only memory (ROM) 906 or any other static storage device coupled to the bus 910 for storing static information, including instructions, that is not changed by the computer system 900. Some memory is composed of volatile storage that loses the information stored thereon when power is lost. Also coupled to bus 910 is a non-volatile (persistent) storage device 908, such as a magnetic disk, optical disk or flash card, for storing information, including instructions, that persists even when the computer system 900 is turned off or otherwise loses power.

Information, including instructions for efficiently utilizing sensor data for auto bookmarking of information in one or more applications, is provided to the bus 910 for use by the processor from an external input device 912, such as a keyboard containing alphanumeric keys operated by a human user, or a sensor. A sensor detects conditions in its vicinity and transforms those detections into physical expression compatible with the measurable phenomenon used to represent information in computer system 900. Other external devices coupled to bus 910, used primarily for interacting with humans, include a display device 914, such as a cathode ray tube (CRT), a liquid crystal display (LCD), a light emitting diode (LED) display, an organic LED (OLED) display, a plasma screen, or a printer for presenting text or images, and a pointing device 916, such as a mouse, a trackball, cursor direction keys, or a motion sensor, for controlling a position of a small cursor image presented on the display 914 and issuing commands associated with graphical elements presented on the display 914. In some embodiments, for example, in embodiments in which the computer system 900 performs all functions automatically without human input, one or more of external input device 912, display device 914, and pointing device 916 is omitted.

In the illustrated embodiment, special purpose hardware, such as an application specific integrated circuit (ASIC) 920, is coupled to bus 910. The special purpose hardware is configured to perform operations not performed by processor 902 quickly enough for special purposes. Examples of ASICs include graphics accelerator cards for generating images for display 914, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 900 also includes one or more instances of a communications interface 970 coupled to bus 910. Communication interface 970 provides a one-way or two-way communication coupling to a variety of external devices that operate with their own processors, such as printers, scanners, and external disks. In general the coupling is with a network link 978 that is connected to a local network 980 to which a variety of external devices with their own processors are connected. For example, communication interface 970 may be a parallel port or a serial port or a universal serial bus (USB) port on a personal computer. In some embodiments, communications interface 970 is an integrated services digital network (ISDN) card or a digital subscriber line (DSL) card or a telephone modem that provides an information communication connection to a corresponding type of telephone line. In some embodiments, a communication interface 970 is a cable modem that converts signals on bus 910 into signals for a communication connection over a coaxial cable or into optical signals for a communication connection over a fiber optic cable. As another example, communications interface 970 may be a local area network (LAN) card to provide a data communication connection to a compatible LAN, such as Ethernet. Wireless links may also be implemented. For wireless links, the communications interface 970 sends or receives or both sends and receives electrical, acoustic, or electromagnetic signals, including infrared and optical signals that carry information streams, such as digital data. For example, in wireless handheld devices, such as mobile telephones like cell phones, the communications interface 970 includes a radio band electromagnetic transmitter and receiver called a radio transceiver. In certain embodiments, the communications interface 970 enables connection to the communication network 111 for efficiently utilizing sensor data for auto bookmarking of information in one or more applications.

The term “computer-readable medium” as used herein refers to any medium that participates in providing information to processor 902, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 908. Volatile media include, for example, dynamic memory 904. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization, or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 920.

Network link 978 typically provides information communication using transmission media through one or more networks to other devices that use or process the information. For example, network link 978 may provide a connection through local network 980 to a host computer 982 or to equipment 984 operated by an Internet Service Provider (ISP). ISP equipment 984 in turn provides data communication services through the public, world-wide packet-switching communication network of networks now commonly referred to as the Internet 990.

A computer called a server host 992 connected to the Internet hosts a process that provides a service in response to information received over the Internet. For example, server host 992 hosts a process that provides information representing video data for presentation at display 914. It is contemplated that the components of system 900 can be deployed in various configurations within other computer systems, e.g., host 982 and server 992.

At least some embodiments of the invention are related to the use of computer system 900 for implementing some or all of the techniques described herein. According to one embodiment of the invention, those techniques are performed by computer system 900 in response to processor 902 executing one or more sequences of one or more processor instructions contained in memory 904. Such instructions, also called computer instructions, software and program code, may be read into memory 904 from another computer-readable medium such as storage device 908 or network link 978. Execution of the sequences of instructions contained in memory 904 causes processor 902 to perform one or more of the method steps described herein. In alternative embodiments, hardware, such as ASIC 920, may be used in place of or in combination with software to implement the invention. Thus, embodiments of the invention are not limited to any specific combination of hardware and software, unless otherwise explicitly stated herein.

The signals transmitted over network link 978 and other networks through communications interface 970, carry information to and from computer system 900. Computer system 900 can send and receive information, including program code, through the networks 980, 990 among others, through network link 978 and communications interface 970. In an example using the Internet 990, a server host 992 transmits program code for a particular application, requested by a message sent from computer 900, through Internet 990, ISP equipment 984, local network 980, and communications interface 970. The received code may be executed by processor 902 as it is received, or may be stored in memory 904 or in storage device 908 or any other non-volatile storage for later execution, or both. In this manner, computer system 900 may obtain application program code in the form of signals on a carrier wave.

Various forms of computer readable media may be involved in carrying one or more sequence of instructions or data or both to processor 902 for execution. For example, instructions and data may initially be carried on a magnetic disk of a remote computer such as host 982. The remote computer loads the instructions and data into its dynamic memory and sends the instructions and data over a telephone line using a modem. A modem local to the computer system 900 receives the instructions and data on a telephone line and uses an infra-red transmitter to convert the instructions and data to a signal on an infra-red carrier wave serving as the network link 978. An infrared detector serving as communications interface 970 receives the instructions and data carried in the infrared signal and places information representing the instructions and data onto bus 910. Bus 910 carries the information to memory 904 from which processor 902 retrieves and executes the instructions using some of the data sent with the instructions. The instructions and data received in memory 904 may optionally be stored on storage device 908, either before or after execution by the processor 902.

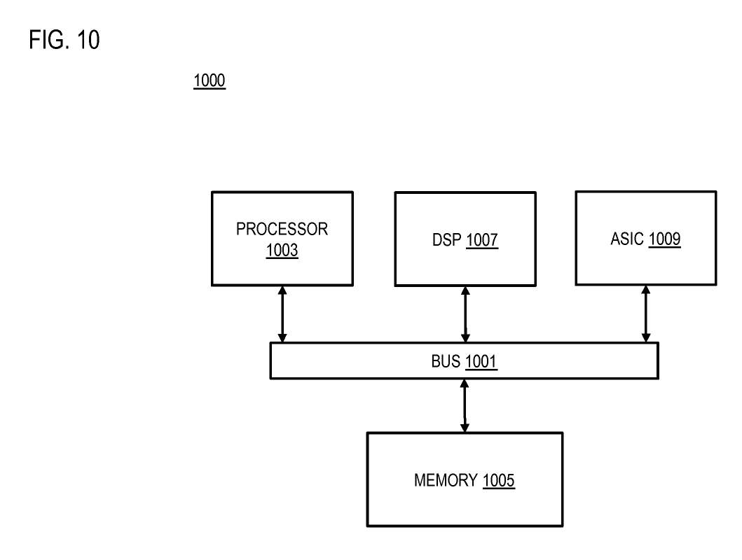

FIG. 10 illustrates a chip set or chip 1000 upon which an embodiment of the invention may be implemented. Chip set 1000 is programmed to efficiently utilize sensor data for auto bookmarking of information in one or more applications as described herein and includes, for instance, the processor and memory components described with respect to FIG. 9 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 1000 can be implemented in a single chip. It is further contemplated that in certain embodiments the chip set or chip 1000 can be implemented as a single “system on a chip.” It is further contemplated that in certain embodiments a separate ASIC would not be used, for example, and that all relevant functions as disclosed herein would be performed by a processor or processors. Chip set or chip 1000, or a portion thereof, constitutes a means for performing one or more steps of providing user interface navigation information associated with the availability of functions. Chip set or chip 1000, or a portion thereof, constitutes a means for performing one or more steps of efficiently utilizing sensor data for auto bookmarking of information in one or more applications.

In one embodiment, the chip set or chip 1000 includes a communication mechanism such as a bus 1001 for passing information among the components of the chip set 1000. A processor 1003 has connectivity to the bus 1001 to execute instructions and process information stored in, for example, a memory 1005. The processor 1003 may include one or more processing cores with each core configured to perform independently. A multi-core processor enables multiprocessing within a single physical package. Examples of a multi-core processor include two, four, eight, or greater numbers of processing cores. Alternatively or in addition, the processor 1003 may include one or more microprocessors configured in tandem via the bus 1001 to enable independent execution of instructions, pipelining, and multithreading. The processor 1003 may also be accompanied with one or more specialized components to perform certain processing functions and tasks such as one or more digital signal processors (DSP) 1007, or one or more application-specific integrated circuits (ASIC) 1009. A DSP 1007 typically is configured to process real-world signals (e.g., sound) in real time independently of the processor 1003. Similarly, an ASIC 1009 can be configured to performed specialized functions not easily performed by a more general purpose processor. Other specialized components to aid in performing the inventive functions described herein may include one or more field programmable gate arrays (FPGA), one or more controllers, or one or more other special-purpose computer chips.

In one embodiment, the chip set or chip 1000 includes merely one or more processors and some software and/or firmware supporting and/or relating to and/or for the one or more processors.

The processor 1003 and accompanying components have connectivity to the memory 1005 via the bus 1001. The memory 1005 includes both dynamic memory (e.g., RAM, magnetic disk, writable optical disk, etc.) and static memory (e.g., ROM, CD-ROM, etc.) for storing executable instructions that when executed perform the inventive steps described herein to efficiently utilize sensor data for auto bookmarking of information in one or more applications. The memory 1005 also stores the data associated with or generated by the execution of the inventive steps.

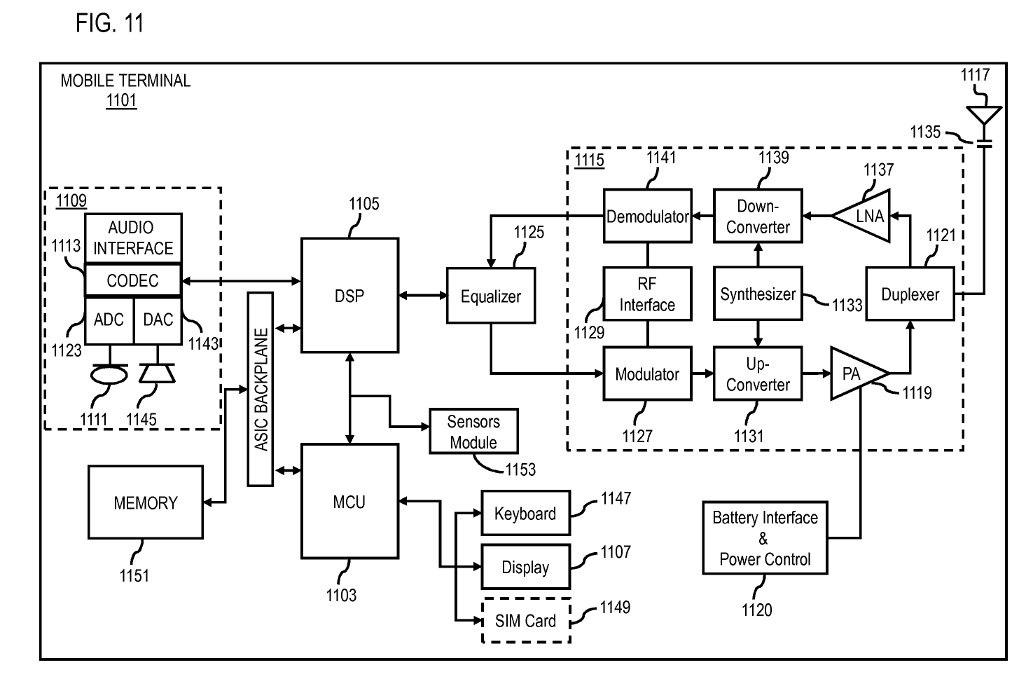

FIG. 11 is a diagram of exemplary components of a mobile terminal (e.g., handset) for communications, which is capable of operating in the system of FIG. 1, according to one embodiment. In some embodiments, mobile terminal 1101, or a portion thereof, constitutes a means for performing one or more steps of efficiently utilizing sensor data for auto bookmarking of information in one or more applications. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1103, a Digital Signal Processor (DSP) 1105, and a receiver/transmitter unit including a microphone gain control unit and a speaker gain control unit. A main display unit 1107 provides a display to the user in support of various applications and mobile terminal functions that perform or support the steps of efficiently utilizing sensor data for auto bookmarking of information in one or more applications. The display 1107 includes display circuitry configured to display at least a portion of a user interface of the mobile terminal (e.g., mobile telephone). Additionally, the display 1107 and display circuitry are configured to facilitate user control of at least some functions of the mobile terminal An audio function circuitry 1109 includes a microphone 1111 and microphone amplifier that amplifies the speech signal output from the microphone 1111. The amplified speech signal output from the microphone 1111 is fed to a coder/decoder (CODEC) 1113.

A radio section 1115 amplifies power and converts frequency in order to communicate with a base station, which is included in a mobile communication system, via antenna 1117. The power amplifier (PA) 1119 and the transmitter/modulation circuitry are operationally responsive to the MCU 1103, with an output from the PA 1119 coupled to the duplexer 1121 or circulator or antenna switch, as known in the art. The PA 1119 also couples to a battery interface and power control unit 1120.

In use, a user of mobile terminal 1101 speaks into the microphone 1111 and his or her voice along with any detected background noise is converted into an analog voltage. The analog voltage is then converted into a digital signal through the Analog to Digital Converter (ADC) 1123. The control unit 1103 routes the digital signal into the DSP 1105 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1125 for compensation of any frequency-dependent impairments that occur during transmission though the air such as phase and amplitude distortion. After equalizing the bit stream, the modulator 1127 combines the signal with a RF signal generated in the RF interface 1129. The modulator 1127 generates a sine wave by way of frequency or phase modulation. In order to prepare the signal for transmission, an up-converter 1131 combines the sine wave output from the modulator 1127 with another sine wave generated by a synthesizer 1133 to achieve the desired frequency of transmission. The signal is then sent through a PA 1119 to increase the signal to an appropriate power level. In practical systems, the PA 1119 acts as a variable gain amplifier whose gain is controlled by the DSP 1105 from information received from a network base station. The signal is then filtered within the duplexer 1121 and optionally sent to an antenna coupler 1135 to match impedances to provide maximum power transfer. Finally, the signal is transmitted via antenna 1117 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1101 are received via antenna 1117 and immediately amplified by a low noise amplifier (LNA) 1137. A down-converter 1139 lowers the carrier frequency while the demodulator 1141 strips away the RF leaving only a digital bit stream. The signal then goes through the equalizer 1125 and is processed by the DSP 1105. A Digital to Analog Converter (DAC) 1143 converts the signal and the resulting output is transmitted to the user through the speaker 1145, all under control of a Main Control Unit (MCU) 1103 which can be implemented as a Central Processing Unit (CPU).

The MCU 1103 receives various signals including input signals from the keyboard 1147. The keyboard 1147 and/or the MCU 1103 in combination with other user input components (e.g., the microphone 1111) comprise a user interface circuitry for managing user input. The MCU 1103 runs a user interface software to facilitate user control of at least some functions of the mobile terminal 1101 for efficiently utilizing sensor data for auto bookmarking of information in one or more applications. The MCU 1103 also delivers a display command and a switch command to the display 1107 and to the speech output switching controller, respectively. Further, the MCU 1103 exchanges information with the DSP 1105 and can access an optionally incorporated SIM card 1149 and a memory 1151. In addition, the MCU 1103 executes various control functions required of the terminal. The DSP 1105 may, depending upon the implementation, perform any of a variety of conventional digital processing functions on the voice signals. Additionally, DSP 1105 determines the background noise level of the local environment from the signals detected by microphone 1111 and sets the gain of microphone 1111 to a level selected to compensate for the natural tendency of the user of the mobile terminal 1101.

The CODEC 1113 includes the ADC 1123 and DAC 1143. The memory 1151 stores various data including call incoming tone data and is capable of storing other data including music data received via, e.g., the global Internet. The software module could reside in RAM memory, flash memory, registers, or any other form of writable storage medium known in the art. The memory device 1151 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1149 carries, for instance, important information, such as the cellular phone number, the carrier supplying service, subscription details, and security information. The SIM card 1149 serves primarily to identify the mobile terminal 1101 on a radio network. The card 1149 also contains a memory for storing a personal telephone number registry, text messages, and user specific mobile terminal settings.

Additionally, sensors module 1153 may include various sensors, for instance, a location sensor, a speed sensor, an audio sensor, an image sensor, a brightness sensor, a biometrics sensor, various physiological sensors, a directional sensor, and the like, for capturing various data associated with the mobile terminal 1101 (e.g., a mobile phone), a user of the mobile terminal 1101, an environment of the mobile terminal 1101 and/or the user, or a combination thereof, wherein the data may be collected, processed, stored, and/or shared with one or more components and/or modules of the mobile terminal 1101 and/or with one or more entities external to the mobile terminal 1101.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1-20. (canceled)

21. A method comprising facilitating a processing of and/or processing (1) data and/or (2) information and/or (3) at least one signal, the (1) data and/or (2) information and/or (3) at least one signal based, at least in part, on the following:
a processing of sensor data to determine one or more items at which at least one user is looking, one or more information items associated with the one or more items, or a combination thereof; and
a bookmarking of the one or more items, the one or more information items, or a combination thereof in at least one application.

22. A method of claim 21, wherein the sensor data includes location information, head-tracking information, gaze-tracking information, physical movement information, one or more user gestures, or a combination thereof.

23. A method of claim 21, wherein the (1) data and/or (2) information and/or (3) at least one signal are further based, at least in part, on the following: a capture of at least one image of the one or more items; and
a tagging of the at least one image with location information associated with at least one user determined at least substantially concurrently with the at least one user looking at the one or more items.

24. A method of claim 21, wherein the (1) data and/or (2) information and/or (3) at least one signal are further based, at least in part, on the following:
at least one determination that the sensor data indicates a movement of the at least one user above a threshold criterion; and
an activation of at least one camera device for capturing the at least one image.

25. A method of claim 23, wherein the (1) data and/or (2) information and/or (3) at least one signal are further based, at least in part, on the following:
a processing of the at least one image, the sensor data, or a combination thereof to cause, at least in part, an identification of the one or more items,
wherein the bookmarking is further based, at least in part, on the identification.

26. A method of claim 21, wherein the (1) data and/or (2) information and/or (3) at least one signal are further based, at least in part, on the following:
at least one determination of one or more neighboring items associated with the one or more items, wherein the bookmarking includes, at least in part, the one or more neighboring items, associated information, or a combination thereof.

27. A method of claim 21, wherein the (1) data and/or (2) information and/or (3) at least one signal are further based, at least in part, on the following:
at least one determination of at least one direction along which the at least one user is looking based, at least in part, on the sensor data; and
at least one determination of the one or more items based, at least in part, on the at least one direction.

28. A method of claim 21, wherein the (1) data and/or (2) information and/or (3) at least one signal are further based, at least in part, on the following:
at least one determination of an input from the at least one user for specifying at least one search; and
at least one determination of at least one result for the at least one search based, at least in part, on the bookmarking.

29. A method of claim 28, wherein the (1) data and/or (2) information and/or (3) at least one signal are further based, at least in part, on the following:
at least one determination of at least one other user within proximity of the at least one user when performing the at least one search;
at least one determination of at least one other bookmarking based, at least in part, on sensor data associated with the at least one other user; and
at least one determination of the at least one result, a weighting of the at least one result, or a combination thereof based, at least in part, on the at least one other bookmarking.

30. A method of claim 21, wherein the (1) data and/or (2) information and/or (3) at least one signal are further based, at least in part, on the following:
a presentation of content information associated with the one or more items to the at least one user.

31. An apparatus comprising:
at least one processor; and
at least one memory including computer program code for one or more programs,
the at least one memory and the computer program code configured to, with the at least one processor, cause the apparatus to perform at least the following,
process and/or facilitate a processing of sensor data to determine one or more items at which at least one user is looking, one or more information items associated with the one or more items, or a combination thereof; and
cause, at least in part, a bookmarking of the one or more items, the one or more information items, or a combination thereof in at least one application.

32. An apparatus of claim 31, wherein the sensor data includes location information, head-tracking information, gaze-tracking information, physical movement information, one or more user gestures, or a combination thereof.

33. An apparatus of claim 31, wherein the apparatus is further caused to:
cause, at least in part, a capture of at least one image of the one or more items; and
cause, at least in part, a tagging of the at least one image with location information associated with at least one user determined at least substantially concurrently with the at least one user looking at the one or more items.

34. An apparatus of claim 31, wherein the apparatus is further caused to:
determine that the sensor data indicates a movement of the at least one user above a threshold criterion; and
cause, at least in part, an activation of at least one camera device for capturing the at least one image.

35. An apparatus of claim 33, wherein the apparatus is further caused to:
process and/or facilitate a processing of the at least one image, the sensor data, or a combination thereof to cause, at least in part, an identification of the one or more items,
wherein the bookmarking is further based, at least in part, on the identification.

36. An apparatus of claim 31, wherein the apparatus is further caused to:
determine one or more neighboring items associated with the one or more items, wherein the bookmarking includes, at least in part, the one or more neighboring items, associated information, or a combination thereof.

37. An apparatus of claim 31, wherein the apparatus is further caused to:
determine at least one direction along which the at least one user is looking based, at least in part, on the sensor data; and
determine the one or more items based, at least in part, on the at least one direction.

38. An apparatus of claim 31, wherein the apparatus is further caused to:
determine an input from the at least one user for specifying at least one search; and
determine at least one result for the at least one search based, at least in part, on the bookmarking.

39. An apparatus of claim 38, wherein the apparatus is further caused to:
determine at least one other user within proximity of the at least one user when performing the at least one search;
determine at least one other bookmarking based, at least in part, on sensor data associated with the at least one other user; and
determine the at least one result, a weighting of the at least one result, or a combination thereof based, at least in part, on the at least one other bookmarking.

40. An apparatus of claim 31, wherein the apparatus is further caused to:
cause, at least in part, a presentation of content information associated with the one or more items to the at least one user.
